(19) United States
(12) Patent Application Publication
(10) Pub. No.: US 2007/0002940 A1
(43) Pub. Date: Jan. 4, 2007

(54) Modem with exclusively selectable echo canceller and high pass filter for near-end signal removal

(76) Inventor: Yan Zhou, Austin, TX (US)

Correspondence Address: DAVIS & ASSOCIATES, P.O. BOX 1093, DRIPPING SPRINGS, TX, 78620, US

(21) Appl. No.: 11/173,997

(22) Filed: Jun. 30, 2005

(51) Int. Cl. H04B 1/38

(52) U.S. Cl. 375/222

(57) ABSTRACT

A communication apparatus includes a modem coupled to a subscriber line carrying a composite signal. The composite signal includes a near-end transmitted signal and a far-end transmitted signal. The modem includes a high pass filter and an echo canceller. The composite signal is exclusively provided to a selected one of the echo canceller and the high pass filter to remove a near-end transmitted signal from the composite signal.

### FIELD OF THE INVENTION

This invention relates to the field of telecommunications. In particular, this invention is drawn to discrete multi-tone modulated digital signals.

### BACKGROUND

The plain old telephone system (POTS) was initially architected to carry voice data in analog form from one subscriber to another via configurable switches. Although the telephone network evolved to using a digital transport network (i.e., the Public Switched Telephone Network (PSTN)), communication on the subscriber line connecting subscribers to the central office that serves as the entry point to the PSTN is predominately analog. The “last mile” between the subscriber and the central office was architected for analog communications in the voiceband frequency range. Digital communications were accomplished using modems operating within the voiceband communications spectrum.

Numerous communication protocol standards have since developed to enable using the POTS infrastructure for communicating digital data at higher data rates by utilizing a communication bandwidth greater than that of the voiceband. Protocols (xDSL) for digital subscriber line services typically limit their communication spectrum to a range that is not used for voiceband communications. As a result, xDSL services may co-exist with voiceband communications on the same subscriber line.

There are multiple line coding or signal modulation techniques for xDSL. xDSL transceivers must perform functions such as near end signal removal, adaptive channel equalization, symbol/bit conversion, timing recovery, and constellation mapping. Some xDSL variants use an encoding strategy such as Reed-Solomon or trellis coding prior to transmission in order to facilitate error-correction at the receiver.

A modulation technique such as Discrete Multi-Tone (DMT) modulation divides the xDSL communication band into an upstream channel and a downstream channel. Each of these channels is further subdivided into a plurality of sub-channels. Each sub-channel is associated with a unique carrier. The carriers are individually modulated to communicate information on each of the sub-channels from the transmitter to the receiver.

An xDSL modem is used to recover the digital data carried by the DMT modulated signal on the subscriber line. Recovery of the digital data involves application of a spectral transform such as a fast Fourier transform (FFT) to the DMT modulated signal. Computation of the FFT is computationally expensive. Although an xDSL modem may include a digital signal processor (DSP) or other integrated circuit for computing the FFT, such integrated circuits tend to add significantly to the cost and power consumption of the xDSL modem.

### SUMMARY

A communication apparatus includes a modem coupled to a subscriber line carrying a composite signal. The composite signal includes a near-end transmitted signal and a far-end transmitted signal. The modem includes a high pass filter and an echo canceller. The composite signal is exclusively provided to a selected one of the echo canceller and the high pass filter to remove a near-end transmitted signal from the composite signal.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a communications network architecture supporting xDSL and POTS communications.

FIG. 2 illustrates one embodiment of a communication spectrum allocation for a subscriber line.

FIG. 3 illustrates one embodiment of a host computer.

FIG. 4 illustrates various components of one embodiment of an xDSL modem.

FIG. 5 illustrates filter profiles for the modem of FIG. 4.

FIG. 6 illustrates one embodiment of a multi-stage FFT.

FIG. 7 illustrates another embodiment of a multi-stage FFT.

FIG. 8 illustrates one embodiment of a method of performing a spectral transform.

FIG. 9 illustrates differences between widths of populated channels of xDSL variants.

FIG. 10 illustrates one embodiment of a method of scaling a spectral transform in accordance with a channel width.

FIG. 11A illustrates a channel and available sub-channels.

FIG. 11B illustrates selection of a subset of available sub-channels across the channel.

FIG. 11C illustrates selection of a clustered subset of available sub-channels across a portion of the channel.

FIG. 12 illustrates one embodiment of a method of scaling a spectral transform in accordance with a number of sub-channels.

FIG. 13 illustrates one embodiment of a method of scaling a spectral transform in accordance with a channel bit-rate.

FIG. 14 illustrates one embodiment of a method of sharing computational resources between a spectral transform and error decoding functions.

FIG. 15 illustrates one embodiment of a method of sharing computational power between an echo canceller and a high pass filter.

### DETAILED DESCRIPTION

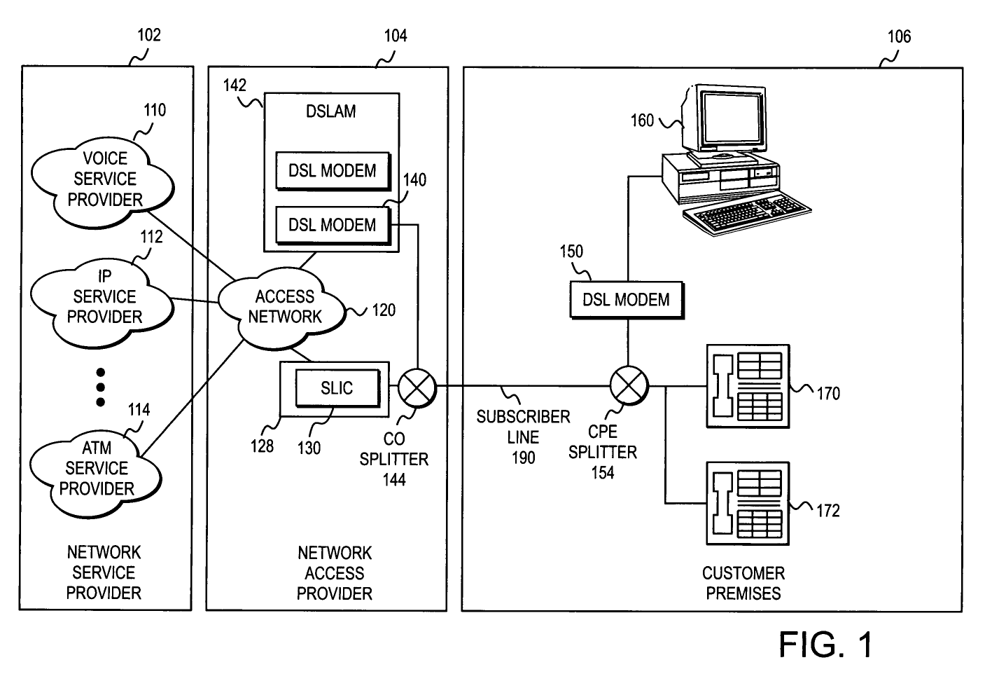

FIG. 1 illustrates an embodiment of a communications network model supporting voice and digital services (e.g., xDSL) on a common subscriber line 190. The network model is divided into three physical domains: network service provider(s) 102, network access providers 104, and customer premises 106.

The network service providers (NSP) may have networks that span large geographic areas. Typically, however, the customer premises (CP) must be located within a specified distance of the network access provider (NAP) as a result of electrical specifications on the subscriber line 190. Thus network access providers typically have a number of central offices (CO) that support customers within a specified radius. Local exchange carriers (LEC) and competitive local exchange carriers (CLEC) are examples of network access providers.

In one embodiment, the network access provider is a telephone company. Subscriber equipment (i.e., customer premises equipment such as telephones 170, 172) is connected to a central office (CO) of the network access provider 104 via a subscriber line 190. For plain old telephone systems (POTS), the subscriber line includes a tip line and a ring line that are typically implemented as an unshielded twisted copper wire pair. The tip line, ring line, and subscriber equipment form a subscriber loop.

The central office has numerous POTS linecards 128 for supporting multiple subscriber lines. Each linecard has at least one subscriber line interface circuit (SLIC) 130 that serves as an interface between a digital switching access network 120 of a local telephone company central office and the subscriber equipment 170, 172. The SLIC is expected to perform a number of functions often collectively referred to as the BORSCHT requirements. BORSCHT is an acronym for “battery feed,” “overvoltage protection,” “ring,” “supervision,” “codec,” “hybrid,” and “test” (e.g., loop diagnostics). The NAP access network 120 couples the POTS linecard to a voice provider network 110 such as the public switched telephone network (PSTN) for bi-directional communication with other subscribers similarly coupled to the voice provider network.

Historically, the network access providers served to connect customers or subscribers to the PSTN for voiceband communications (communications having an analog bandwidth of approximately 4 kHz or less). Although the PSTN is digital in nature, the connection (subscriber line 190) between the customer premises 106 and the network access provider 104 is analog.

The subscriber line may be provisioned for additional services by using communication channels outside the voiceband. Thus, for example, digital subscriber line services may simultaneously co-exist with voiceband communications by using channels other than the voiceband. The choice of frequency ranges and line codes for these additional services is the subject of various standards. The International Telecommunication Union (ITU), for example, has set forth a series of recommendations for subscriber line data transmission. These recommendations are directed towards communications using the voiceband portion of the communications spectrum (“V.x” recommendations) as well as communications utilizing frequency spectrum other than the voiceband portion (e.g., “xDSL” recommendations). Various examples of line code standards include quadrature amplitude and phase modulation, discrete multi-tone modulation, carrierless amplitude phase modulation, and two binary one quaternary (2B1Q).

Asymmetric digital subscriber line (ADSL) communications represent one variant of xDSL communications. Exemplary ADSL specifications are set forth in “Rec. G.992.1 (06/99)—Asymmetric digital subscriber line (ADSL) transceivers” (also referred to as full rate ADSL), and “Rec. G.992.2 (06/99)—Splitterless asymmetric digital subscriber line (ADSL) transceivers” (also referred to as G.LITE).

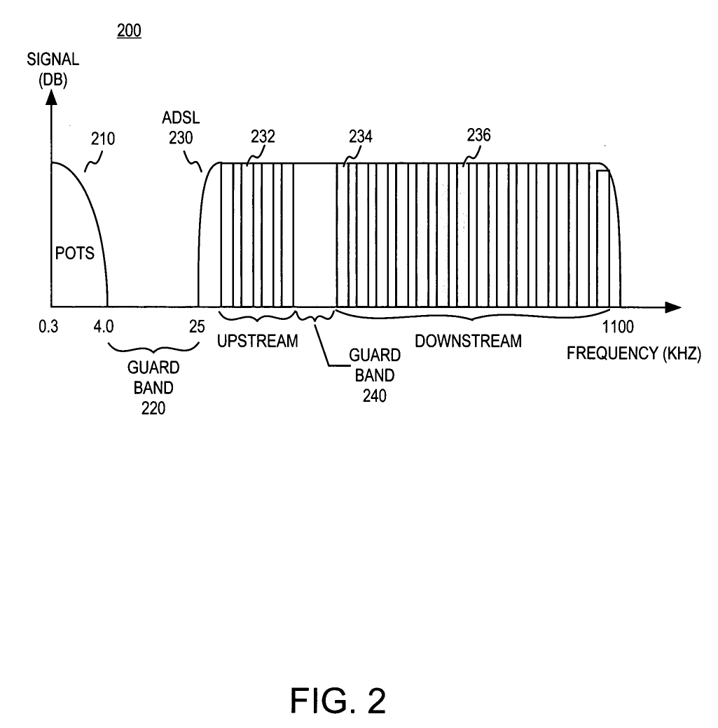

FIG. 2 illustrates one embodiment of communication spectrum allocation for a subscriber line. Chart 200 compares the portions of the spectrum used for voiceband applications (POTS 210) as well as digital services (e.g., ADSL 230). POTS communications typically use the voiceband range of 300-4000 Hz. One xDSL variant uses frequencies beyond the voiceband in the range of approximately 25-1100 kHz as indicated. A guard band 220 separates the POTS and ADSL ranges.

There are multiple line coding variations for xDSL. Carrierless Amplitude Phase (CAP) modulation and Discrete Multi-Tone (DMT) modulation both use the fundamental techniques of quadrature amplitude modulation (QAM). CAP is a single carrier protocol where the carrier is suppressed before transmission and reconstructed at the receiving end. DMT is a multicarrier protocol. FIG. 2 illustrates DMT line coding.

DMT modulation has been established as a standard line code for ADSL communication. For full-rate ADSL the available bandwidth is divided into 256 sub-channels. The available bandwidth and the number of sub-channels varies with ADSL variants. G.Lite, for example, has a 552 Khz upper channel boundary. ADSL2+ has an upper channel boundary of 2.2 MHz, effectively doubling the available bandwidth and the number of sub-channels with respect to full-rate ADSL.

Each sub-channel 234 is associated with a carrier. The carriers (also referred to as tones) are spaced 4.3125 KHz apart. Each sub-channel is modulated using quadrature amplitude modulation (QAM) and can carry 0-15 bits/Hz. The actual number of bits is allocated depending upon line conditions. Thus individual sub-channels may be carrying different numbers of bits/Hz. Some sub-channels 236 might not be used at all.

In one embodiment, ADSL uses some sub-channels 234 for downstream communication and other sub-channels 232 for upstream communication (i.e., frequency division multiplexed (FDM) ADSL). The upstream and downstream sub-channels may be separated by another guard band 240. ADSL is named for the asymmetry in bandwidth allocated to upstream compared to the bandwidth allocated to downstream communication.

During initialization the signal-to-noise ratio of each DMT sub-channel is measured to determine an appropriate data rate assignment. Generally, greater data rates (i.e., more bits/Hz) are assigned to the lower sub-channels because signals are attenuated more at higher frequencies. DMT implementations may also incorporate rate adaption to monitor the line conditions and dynamically change the data rate for sub-channels. xDSL can be provisioned using the same subscriber line as that used for standard POTS communications thus leveraging existing infrastructure. The availability of xDSL technology permits delivery of additional services to the subscriber.

Referring to FIG. 1, a digital subscriber line access multiplexer (DSLAM) 142 has a plurality of DSL linecards with DSL modems 140. These modems are also referred to as ATU-C (central office ADSL Transceiver Unit) for ADSL applications. The access network 120 enables communication with digital network service providers such as Internet protocol (IP) service providers 112 and asynchronous transfer mode (ATM) service providers 114. A DSLAM modem linecard provides a connection from one of the digital networks via access network 120 to the subscriber line 190 through the use of a central office splitter 144.

The splitter 144 serves to filter the appropriate portion of the subscriber line 190 communications for both the DSL modem linecard 140 and the POTS linecard 128. In particular, the splitter eliminates the xDSL portion of the subscriber line communications for the POTS linecard 128. The splitter eliminates the voiceband communications for the DSL modem linecard 140. The splitter also protects the DSL modem linecard from the large transients and control signals associated with the POTS communications on the subscriber line.

The CO splitter thus effectively splits upstream communications from the subscriber equipment into at least two spectral ranges: voiceband and non-voiceband. The upstream voiceband range is provided to the POTS linecard and the upstream non-voiceband range is provided to the DSL modem linecard. The splitter couples the distinctly originating downstream voiceband and downstream non-voiceband communications to a common physical subscriber line 190.

A customer premises equipment splitter 154 may also be required at the customer premises for the POTS subscriber equipment 170, 172. The CPE splitter 154 passes only the voiceband portion of the subscriber line communications to the POTS subscriber equipment.

In one embodiment, the CPE splitter provides the DSL communications to a DSL modem 150 that serves as a communications interface for digital subscriber equipment such as computer 160. DSL modem 150 may also be referred to as an ATU-R (remote ADSL transceiver unit) for ADSL applications.

The DSL service overlays the existing POTS service on the same subscriber line. This solution avoids the capital costs of placing dedicated digital subscriber lines and permits utilizing existing POTS linecards.

In order to recover the digital data from the subscriber line, a number of signal processing functions must be performed on the DMT modulated signal. Considering that the modem is coupled to a computer system, some of the signal processing functions may be performed by the computer system that serves as the host computer system for the modem in order to reduce the hardware costs associated with implementing the functionality entirely within the modem.

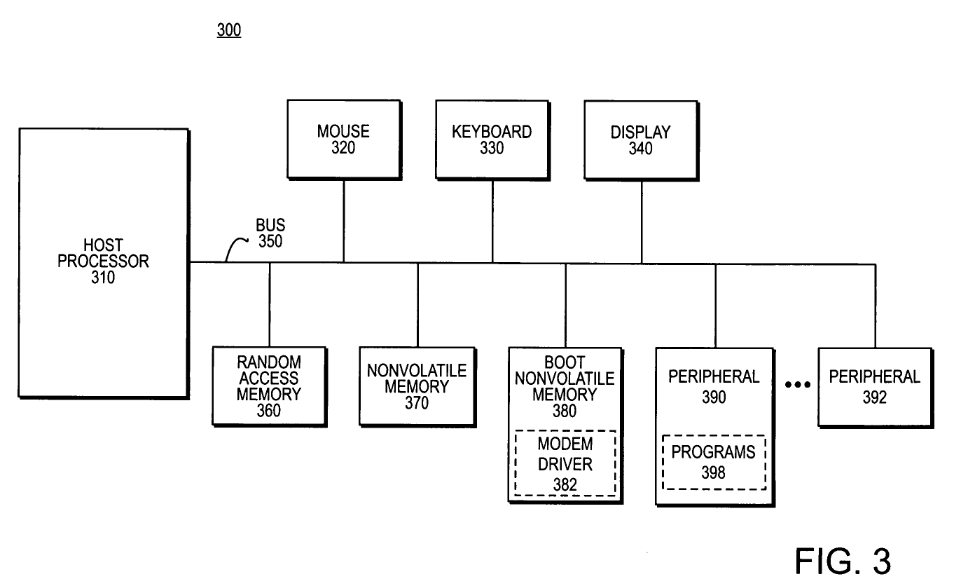

FIG. 3 illustrates one embodiment of a host computer system architecture. Computer 300 includes host processor 310. Input devices such as mouse 320 and keyboard 330 permit the user to input data to computer 300. Information generated by the processor is provided to an output device such as display 340. Computer 300 includes random access memory (RAM) 360 used by the processor during program execution.

Computer 300 includes nonvolatile memory 370 for storing configuration settings 372 even when the computer is powered down. Parameter information that identifies specific features of the peripheral devices is stored in nonvolatile memory 370. For example, parameter information might describe the number of disk drives, disk drive type, number of heads, tracks, amount of system RAM, etc. as well as the peripheral boot sequence. Typically, nonvolatile memory 370 is a semiconductor-based memory.

Mouse 320, keyboard 330, display 340, RAM 360, nonvolatile memory 370, and boot nonvolatile memory 380 are communicatively coupled to processor 310 through one or more buses such as bus 350. The boot nonvolatile memory 380 stores the bootstrap loader and typically stores other initialization routines such as power on system test (POST).

The computer also has one or more peripherals 390, 392 such as a floppy drive, a hard drive, or an optical drive that supports nonvolatile storage. Compact disks (CDs) and Digital Video Disks (DVDs) are examples of media used with optical drives. Software applications are typically stored as groupings of processor-executable instructions (i.e., programs 398) residing on a hard drive (i.e., an electromechanical nonvolatile memory utilizing platters of magnetic medium).

The xDSL modem is implemented at least in part as one of the peripherals of the computer system. The xDSL modem may be implemented as an integrated peripheral (i.e., within the computer system enclosure) or an external peripheral (i.e., outside the computer system enclosure).

An integrated peripheral, for example, is typically on the motherboard supporting the host processor or in a host computer expansion slot located within a host computer enclosure. The expansion slot couples the peripheral to the host processor through an input/output bus such as the Peripheral Component Interconnect (PCI) bus.

An external peripheral is located external to the host computer enclosure and is typically coupled to the computer through a serial communications interface such as a Firewire® or Universal Serial Bus (USB) interface.

The boot nonvolatile memory may include routines for communicating with peripheral devices such as the modem in the computer system. In some computer systems these routines are collectively referred to as the Basic Input Output System (BIOS). The BIOS provides a common software interface so that software executing on the processor can communicate with peripheral devices such as the keyboard, mouse, nonvolatile mass memory storage device, and other peripheral devices such as modems. The BIOS may thus contain processor-executable instructions or data structures forming at least part of a modem driver 372. The modem driver may alternatively reside at least in part on another peripheral such as a hard drive.

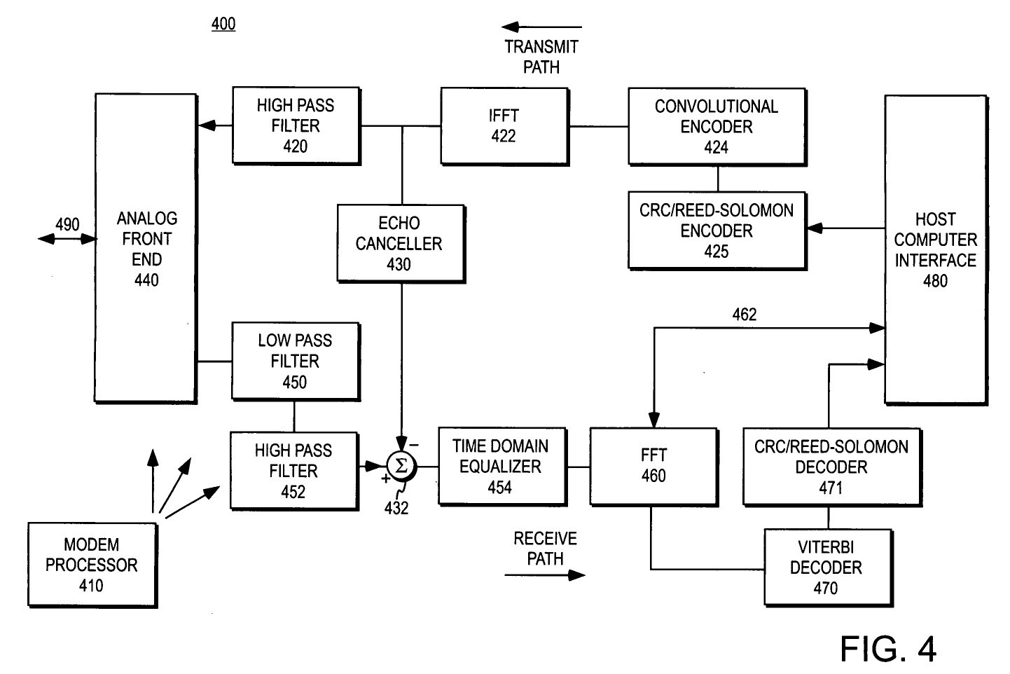

FIG. 4 illustrates one embodiment of various components of an ADSL modem. This modem will be described from the perspective of the subscriber equipment (i.e., as an ATU-R) and associated host computer such that “upstream” implies transmission from the DSL modem to the central office and “downstream” implies reception from the central office. “Far end” refers to the transceiver located at the distal end of the subscriber line from the perspective of the proximal or “near end” transceiver. The modem must perform both modulation for transmission of digital data and demodulation to recover digital data from a received modulated signal. Although not explicitly illustrated, the modem may also include distinct functional blocks for constellation mapping, symbol mapping, interleaving, symbol de-mapping, de-interleaving, frequency domain equalization, etc.

The modem is coupled to the subscriber line 490 through an analog front end 440. The analog front end includes digital-to-analog converters for the upstream signal and analog-to-digital converters for the downstream signal.

The modem is coupled to a host computer through a host computer interface 480. In various embodiments, the modem may be implemented at least in part as an integrated peripheral of the host computer (e.g., an internal modem) or a peripheral external to the host computer. Thus the host computer interface 380 may have a bus interface such as a PCI bus interface if the modem is an integrated peripheral or a serial communications interface such as Firewire® or USB if the modem is an external peripheral.

The upstream transmit path from the host computer includes error pre-coding and inverse spectral transformation. Digital data received from the host computer for upstream communication may be error coded through the use of a cyclic reduncy check (CRC) and Reed-Solomon encoder 425. The purpose of the CRC/Reed-Solomon encoder 425 is to facilitate error detection at the receiver. The digital data may also be encoded (or “pre-coded”), for example, with a convolutional encoder 424 to facilitate detection of the modulated signal at the receiver or far-end. Trellis coding is frequently used for the convolutional encoding.

An inverse spectral transform such as an inverse fast Fourier transform (IFFT 422) is performed to determine the appropriate time domain signal. The output of the IFFT is provided to the AFE 440 so that the modulated signal may be communicated to the far-end transceiver over the subscriber line 490.

Given that the upstream signal and downstream signal are communicated on the same wire pair of the subscriber line 490, the signal that the AFE extracts from the subscriber line is a composite signal containing both the downstream signal transmitted by the far-end and the upstream signal transmitted by the near-end. The composite signal may be applied to a first low pass filter 450 for eliminating out-of-band signals (i.e., eliminating signals above the ADSL band). The low pass filtered composite signal may be applied to a high pass filter 452 to extract just the downstream channel portion of the xDSL communications.

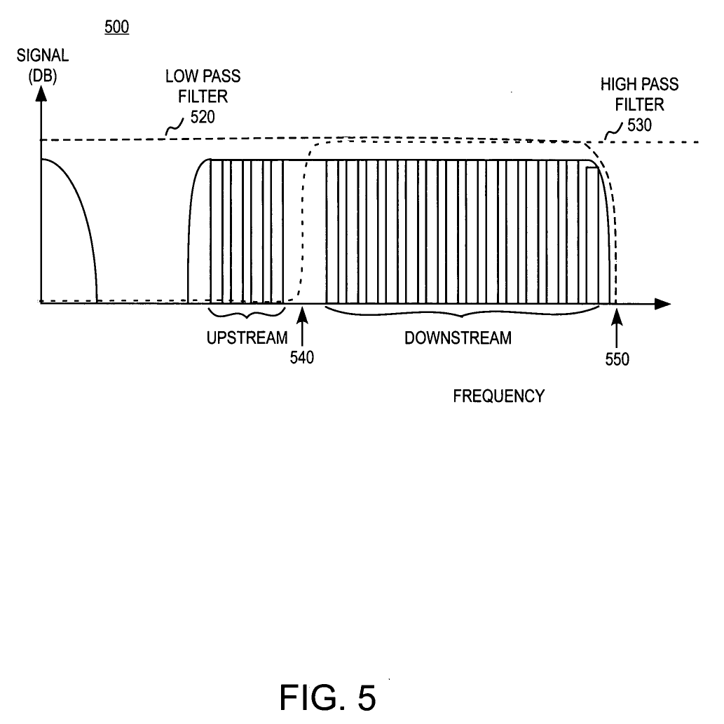

The profiles of the high pass filter 452 and low pass filter 450 are illustrated in FIG. 5. The low pass filter profile 520 substantially eliminates any out-of-band contributions. Thus the low pass filter eliminates frequencies above the upper bound 550 of the xDSL communications (which coincides with the upper bound of the downstream channel). In one embodiment, the low pass filter is implemented as a 6^{th} order or higher digital filter. The high pass filter profile 530 eliminates frequencies below the lower bound 540 of the downstream channel. Thus the low and high pass filters co-operate to eliminate frequencies outside of the downstream channel band.

Referring to FIG. 4, the modem may have an echo canceller 430 and summer 432 to aid in the removal of the near-end upstream channel. A time domain equalizer 454 may be used to aid in sub-channel isolation. A spectral transform is then performed on the equalized signal. For example, the spectral transform may be a discrete Fourier transform (DFT).

In one embodiment, the spectral transform is staged. The spectral transform can be implemented, for example, as a multi-staged fast Fourier transform (FFT) 460. The output of the multi-staged FFT is provided to a convolutional decoder such as Viterbi decoder 470. In one embodiment, the convolutional decoder is a trellis decoder. The output of the trellis decoder may then be provided to the CRC/Reed-Solomon decoder 471 for error detection. The result is then provided to the host computer interface 480 for communication to the host computer.

The modem may be implemented in hardware using a number of integrated circuits, however, one or more of the functional components of the modem may be implemented either on a host processor or a modem processor as processor-executable instructions. Thus, for example, the peripheral portion of the modem might consist of little more than an “enhanced” analog front end with several of the illustrated components implemented digitally by the host processor or on-board by a modem processor. In one embodiment, one or more of filters 420, 450, 452 and the echo canceller 430 are implemented digitally using either a modem processor 410 or the host processor 310 of FIG. 3. Each of the IFFT 422, convolutional encoder 424, CRC/Reed-Solomon encoder 425, Viterbi decoder 470, CRC/Reed-Solomon decoder 471, FFT 460, and time domain equalizer 454 functions must similarly be performed by the host or modem processors. In various embodiments, the modem processor 410 is a digital signal processor (DSP), an application specific integrated circuit (ASIC) or perhaps a field programmable gate array (FPGA).

The cost of the modem processor is generally related to the amount of integrated circuit die space required to implement the functions and the speed with which the functions must be performed. Although the need for a modem processor can be reduced by implementing most of the functions using the host processor, such an implementation tends to consume significant portions of the host's computational power to the detriment of the user. However, the cost of the modem processor may be significantly reduced by the appropriate distribution of functionality between the modem processor and host processor.

Without optimization, an N-point discrete Fourier transform requires on the order of N² floating point operations. A 1,024 point DFT, for example, requires in excess of 2 million floating point operations (multiplications and additions). The fast Fourier transform (FFT) recognizes periodicity in the transform process and re-arranges the operations to facilitate elimination of redundant operations. The FFT requires on the order of N(logᵣ(N)) operations, where r is the radix of the FFT. A radix-2 FFT with N=1024 would require at least 20,000 floating point operations. Assuming the length of time required for computation is directly proportional to the number of floating point operations being performed, the FFT in this example is 100 times faster than the DFT for the same N.

Although the FFT significantly reduces the computational power required for the modem on a per transform basis when compared with a DFT, the speed with which the FFT must be performed also imposes performance constraints on the modem. Generally, the cost of implementing the FFT increases with the increase in FLOPS (floating point operations per second) or MIPS (millions of instructions per second). The cost of the modem processor tends to increase as the minimum FLOPS or MIPS requirement increases.

Assuming that the number of floating point operations required for the FFT cannot be further reduced, any reduction in FLOPS performed by the modem must be accounted for elsewhere. In one embodiment, FFT FLOPS are shifted from the modem to the host processor.

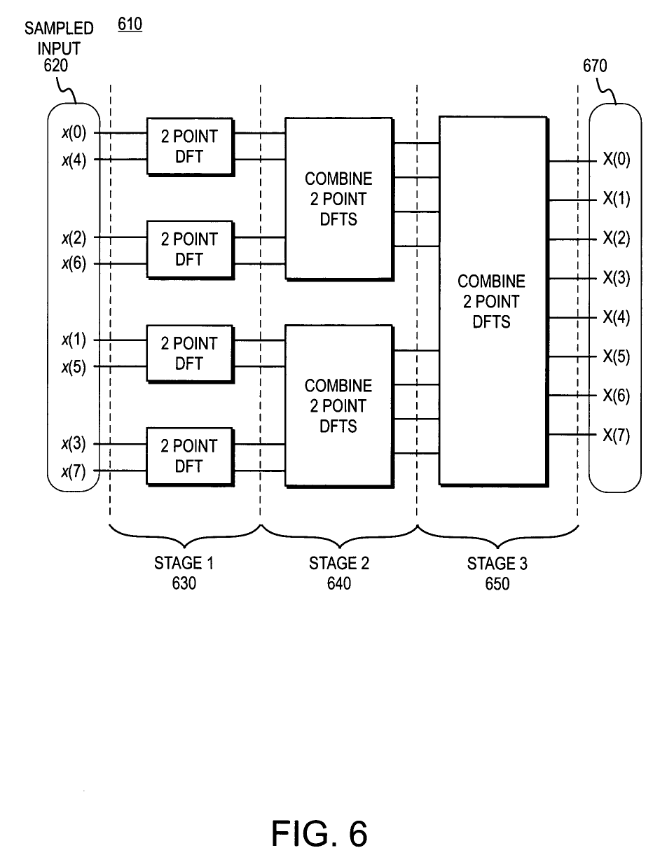

FIG. 6 illustrates one embodiment of a multistage FFT 610. An N point spectral transform vector 670 is computed from an input vector 620. The N point spectral transform is subdivided into stages 630, 640, 650 of transforms, each stage performing the transform on a fewer number of points. In the illustrated embodiment, the final stage 650 produces an 8 point FFT (N=8) from the two point FFTs from stage 640. The 2 point FFTs of stage 640 are produced from the 2 point FFTs of stage 630. The number of calculations required for the FFT is of the order N(logᵣ(N)), where r is referred to as the “radix” of the FFT. When N is a power of 2 (i.e., N=2^{p} where p is an integer), radix-2, radix-4, radix-8, radix-16, radix-32 are typical radices.

The FFT is not limited to the use of a single radix for the computation. In various embodiments, the FFT is performed using a mixed or split radix. For N=1000, radix-2 may be used for some stages while radix-5 is used for other stages for example (i.e., radix-2, 5 FFT with N=1000).

The FFT may be performed using decimation in time (DIT) or decimation in frequency (DIF). The example illustrated in FIG. 6 performs a decimation in time (note the ordering of the input vector 620 in contrast with the ordering of the spectral transform vector 670).

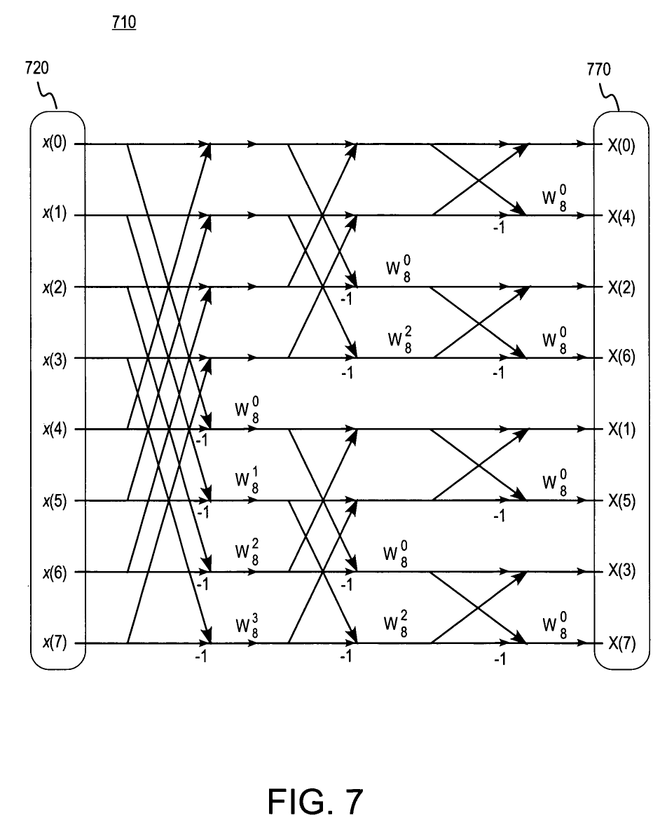

FIG. 7 illustrates a multistage FFT 710 using butterfly notation. The spectral transform is a radix-2 FFT with N=8. Accordingly there are three stages 730, 740, 750. The spectral transform of FIG. 7 is an example of a decimation in frequency FFT (note the ordering of the spectral transform vector 770 in contrast with the ordering of the input vector 720).

The orderings of the input and spectral transform vectors are the result of performing the computation “in place”. Other orderings of the input or spectral transform vector depending upon the implementation of the FFT.

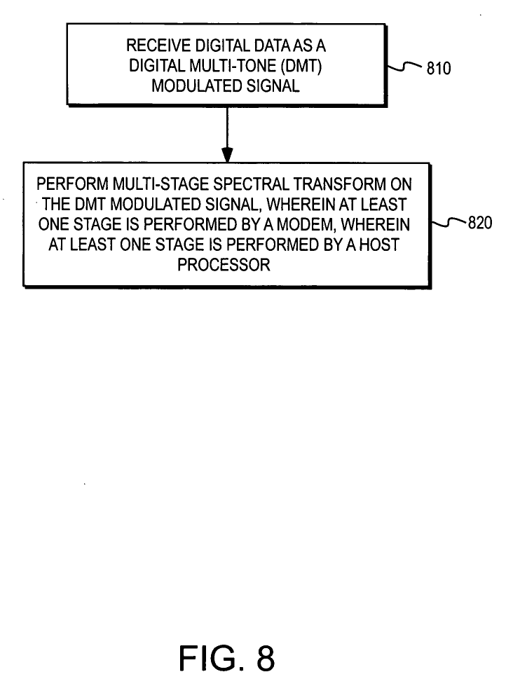

In an effort to trade-off cost of the modem without unduly taxing the host processor, computation of the FFT is performed in part by the modem and in part by the host processor. One embodiment of a method of sharing the FFT computation between the host processor and the modem is illustrated in FIG. 8.

In step 810, digital data is received as a discrete multi-tone (DMT) modulated signal by a modem coupled to a host processor. In step 820, a multi-stage spectral transform is performed on the DMT signal. At least one stage of the spectral transform is performed by the modem. At least one stage of the spectral transform is performed by the host processor. In one embodiment, the spectral transform is a DFT. In one embodiment, the DFT is performed as an FFT.

The spectral transform might consist of k stages, for example, where m stage(s) are performed by the modem and j stage(s) are performed by the host processor such that m+j=k (m, j≧1). In various embodiments, either the modem or the host processor performs a plurality of stages. Thus the modem may perform a first plurality of stages (i.e., m≧2) and the host processor may perform a second plurality of stages (i.e., j≧2) of the spectral transform.

The multi-stage spectral transform is an N-point transform. In one embodiment N is a power of 2 (i.e., N=2^{p}, where p is an integer). The multi-stage spectral transform may be a single radix transform. Radix-2, radix-4, radix-8, radix-16, and radix-32 are examples of single radix transforms. In an alternative embodiment, the multi-stage spectral transform may utilize mixed radix (e.g., 2, 4-radix or 2, 5-radix).

Given that the result of one stage may be required by a subsequent stage of the multi-stage FFT, the host processor and modem must co-operate to achieve the computation. Communication of input data or stage results (e.g., interim or final) may take place through the host interface 480. The FFT is coupled 462 to the host interface 480 to permit the exchange of input data or interim or final results. For example, the modem may communicate the information required for one or more host processor executed stages via 462 to the host interface 480. The host may return the results, if needed, to the modem FFT block via the host interface 480 and coupling 462. (Although an explicit coupling is illustrated only for the FFT block, other components may similarly be communicatively coupled to the host processor depending upon which functional blocks are performed by the host processor).

Another approach to reducing the minimum number of FLOPS required by the modem is to distribute the computational power as needed rather than sizing the modem processor for a simultaneous “worst case” scenario for each functional unit of the modem. Thus for example, computational resources can be shifted from one functional unit (e.g., FFT) to another (trellis decoder) as needed. When the increased needs of the functional units are mutually exclusive, an opportunity for a reduction in the gross computational power of the modem processor is available.

The FFT, for example, may be scaled when appropriate to reduce its consumption of computational resources. ADSL variants tend to “bottom load” the communication channel. ADSL2+, for example, adds sub-channels to full-rate ADSL by extending the upper bound of the downstream channel to 2.2 MHz. In the event that a substantial amount of noise or signal degradation is encountered, however, ADSL2+ supports switching back to the full-rate ADSL upper limit of 1.1 MHz. The strength of the received signal is related at least in part to the length of the subscriber loop. The strength of the received signal degrades with the length of the subscriber line. Lower received signal levels lead to a lower signal-to-noise ratio and therefore a lower data rate.

The number of points required for the FFT to distinguish sub-channels depends upon the number and distribution of sub-channels within the channel. For example, a standard ADSL2+ modem with bandwidth of 2.208 MHz typically requires a 512 point FFT (i.e., 2.208 MHz/4.3125 Khz=512). For full-rate ADSL, the bandwidth of 1.104 MHz suggests a 256 point FFT. If the data rate is restricted, for example by the service provider, a smaller bandwidth may be used. Thus, for example if the bandwidth is reduced to 552 Khz, then a 128 point FFT can be used. The restrictions in bandwidth can change the number or distribution of sub-channels. In one embodiment, an N-point FFT is scaled to select a different number of points based upon the number of sub-channels.

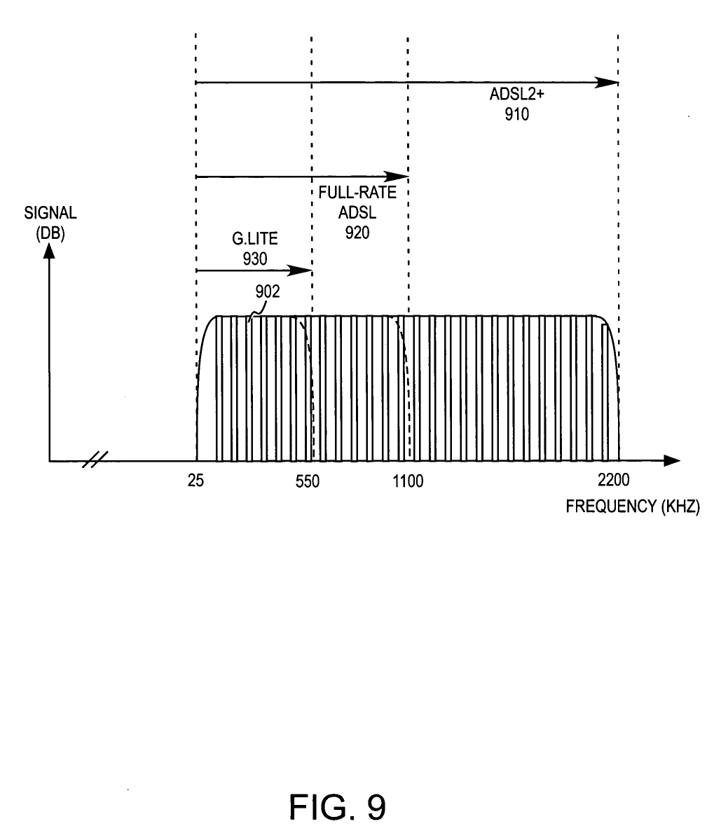

FIG. 9 illustrates differences between a populated ADSL2+ downstream channel 910, a populated full-rate ADSL downstream channel 920, and a populated G.LITE ADSL downstream channel 930. Given that the distance between sub-channels 902 is maintained as a constant, the difference in actual channel size inherently results in a change in the number of sub-channels. The total number of sub-channels available for communication clearly changes with the channel width. Fewer sub-channels in the full-rate ADSL implies that the spectral transform requires fewer points to distinguish between sub-channels as contrasted with the ADSL2+ communication channel. Although FIG. 9 illustrates the upstream and downstream communication channels collectively, the size (K) of the downstream channel and therefore the number of sub-channels used for downstream communications likewise varies between the various xDSL standards.

Referring to FIG. 4, the modem receives digital data as a DMT modulated signal. The DMT modulated signal is communicated on a channel having a width M. The modem processor 410 performs an N-point spectral transform such as an FFT 460 on the DMT modulated signal. The FFT is point scaled in accordance with the width of the channel. N varies in response to M. In one embodiment, there is at least one pre-determined threshold such that if M exceeds the pre-determined threshold, N=N1. If M does not exceed the pre-determined threshold, N=N2, wherein N1>N2. In various embodiments, there may be a plurality of thresholds such that N is selected from one of three or more values in response to M.

In one embodiment, the DMT modulated signal is carried by a subscriber line 490. M may be a measure of the collective channel width or specifically the downstream channel width (K) with the pre-determined threshold(s) selected accordingly.

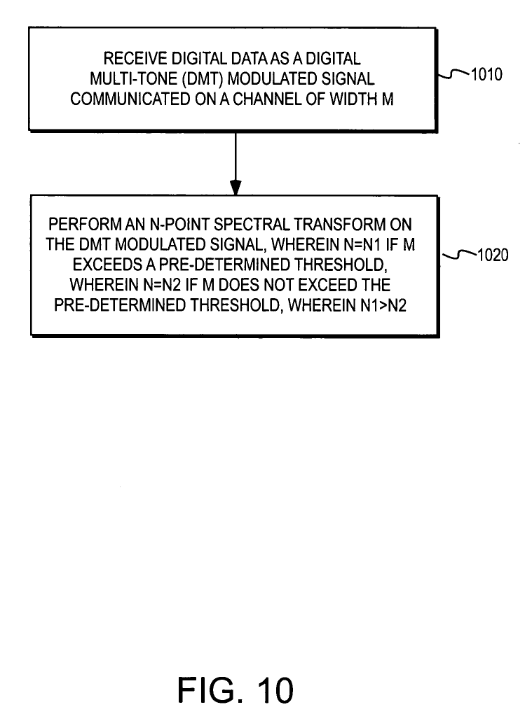

FIG. 10 illustrates one embodiment of a method of scaling a spectral transform in accordance with a channel width. Digital data is received as a DMT modulated signal in step 1010. The DMT modulated signal is communicated on a channel of width M. An N-point spectral transform is performed on the DMT modulated signal in step 1020, wherein N varies in response to M. There is at least one pre-determined threshold such that N=N1, if M exceeds a pre-determined threshold and N=N2, if M does not exceed the pre-determined threshold, wherein N1>N2. In various embodiments there are a plurality of pre-determined thresholds and N is selected from three or more values in response to M.

In various embodiments, the spectral transform is a discrete Fourier transform or a fast Fourier transform. Typical values for N are 128, 256, and 512 depending upon the width of the channel. Given that variants of ADSL tend to vary the channel width by factors of 2, N1/N2 may be a power of 2 in some embodiments.

As previously noted, the minimum required N is a function of the number and distribution of the sub-channels within the channel. Within a given channel having a fixed width and an available number of sub-channels, the number of points required for the spectral transform can be reduced by choosing a subset of the available sub-channels while either 1) increasing the distance between sub-channels, or 2) using only clustered sub-channels which span only a portion of the channel.

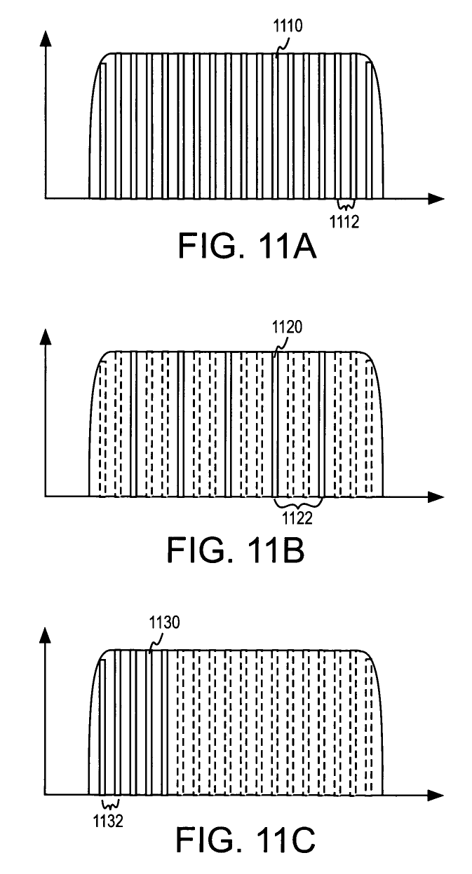

FIG. 11A illustrates a channel having a plurality (K) of available sub-channels 1110. For a given channel width, N can be reduced by proper selection of a subset of the available sub-channels.

FIG. 11B illustrates a subset (M) of the sub-channels 1120 selected across the channel where the M sub-channels are substantially equidistant. Note that the width of the channel is maintained in comparison with FIG. 11A, however, the distance 1122 between selected sub-channels is greater than the distance 1112 between the available sub-channels. In this example, the effective channel width is substantially the same as the actual channel width.

FIG. 11C illustrates a clustered subset (M) of the sub-channels 1130 selected across a portion of the channel. Note that the distance 1132 between selected sub-channels is the same as that for the available sub-channels, however, only a portion of the full channel spectrum is used. In this example, the effective channel width is less than the actual channel width. For the same M, the configuration of FIG. 11C may be able to carry more data than the configuration of FIG. 11B given the higher losses associated with the higher frequency sub-channels.

Referring to FIG. 4, the modem 400 receives digital data as a DMT modulated signal. The DMT modulated signal is communicated on a channel using a plurality (M) of sub-channels selected out of a greater plurality of available sub-channels. Given that the lower frequency sub-channels are typically capable of maintaining a greater bit rate than higher frequency sub-channels, in one embodiment, the selected plurality of sub-channels is clustered near the lower bound of the available channel. In an alternative embodiment, the selected plurality of sub-channels consists of substantially equidistant sub-channels selected across the channel wherein the selected plurality is significantly less (e.g., half or fewer) than the available number of sub-channels supported by the channel.

The modem processor 410 performs an N-point spectral transform such as an FFT 460 on the DMT modulated signal to recover the digital data. The FFT is point scaled in accordance with the number of sub-channels being used. There is at least one pre-determined threshold such that if M exceeds a pre-determined threshold, N=N1. If M does not exceed the pre-determined threshold, N=N2 wherein N1>N2. In one embodiment the DMT modulated signal is carried by a subscriber line 490.

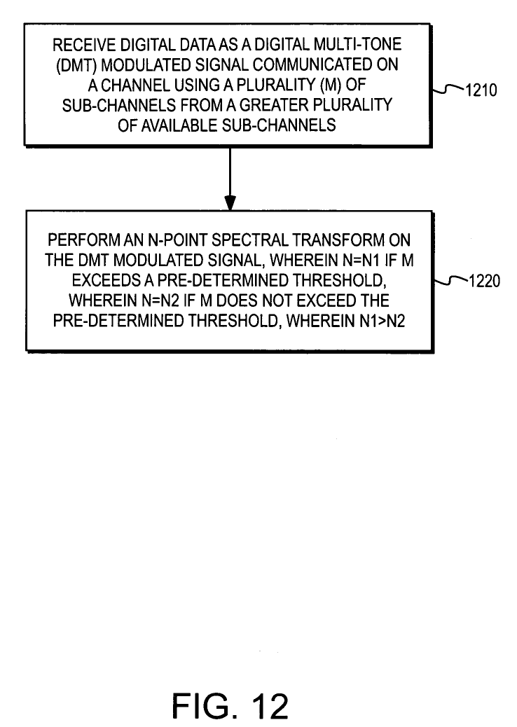

FIG. 12 illustrates one embodiment of a method of scaling a spectral transform in accordance with a number of sub-channels. Digital data is received as a DMT modulated signal in step 1210. The DMT modulated signal is communicated using a selected plurality (M) of sub-channels from a greater plurality of available sub-channels. Typically, the number of sub-channels that may be used varies inversely with the length of the subscriber line. An N-point spectral transform is performed on the DMT modulated signal in step 1220, wherein N varies in response to M.

There is at least one pre-determined threshold such that N=N1, if M exceeds a pre-determined threshold and N=N2, if M does not exceed the pre-determined threshold, wherein N1>N2. In various embodiments there are a plurality of pre-determined thresholds and N is selected from three or more values in response to M. The selected sub-channels may be equidistantly spaced. In one embodiment, the selected sub-channels are clustered within a portion of the channel.

In various embodiments, the spectral transform is a discrete Fourier transform or a fast Fourier transform. Typical values for N are 128, 256, or 512 depending upon the number of sub-channels. Given that variants of ADSL tend to vary the channel width by factors of 2, N1/N2 may be a power of 2 in some embodiments.

The use of less than the available sub-channels implies a lowered maximum bit rate. As previously described, the number of bits carried by each sub-channel may vary. Thus even if the symbol rate is constant, the xDSL standards support varying the bit rate across the channel. In order to obtain the distribution of FIG. 11C, the maximum bit rate may have to be changed.

Although the selected cluster may be near the bottom of the channel to ensure the greatest possible bit rate per selected sub-channel, the use of a subset of the available sub-channels may only be achievable if the required bit rate is reduced even with the “bottom loading” of the clustered sub-channels with a greater number of bits. In other words, the modem may be configured to maximize data rate by “bottom loading” the sub-channels such that the lowest frequency sub-channels tend to have a bit-rate higher than higher frequency sub-channels. Once a threshold bit-rate (M) is reached for the channel, however, the data will have to be distributed across additional sub-channels. The additional sub-channels will require a higher number of points to distinguish them because they cover a greater span of the channel, even though they may be clustered. Thus in one embodiment, the bit-rate is the metric used to determine the number of points for the scalable spectral transform.

Referring to FIG. 4, the modem 400 receives digital data as a DMT modulated signal. The DMT modulated signal is communicated on a channel using a plurality of clustered sub-channels. Given that the lower frequency sub-channels are typically capable of maintaining a greater bit rate than higher frequency sub-channels, in one embodiment, the selected plurality of sub-channels is clustered near the lower bound of the channel.

The modem processor 410 performs an N-point spectral transform such as an FFT 460 on the DMT modulated signal to recover the digital data. The spectral transform is point scaled in accordance with the bit-rate (M) of the channel. There is at least one pre-determined threshold such that if M exceeds a pre-determined threshold, N=N1. If M does not exceed the pre-determined threshold, N=N2 wherein N1>N2. In one embodiment the DMT modulated signal is carried by a subscriber line 490.

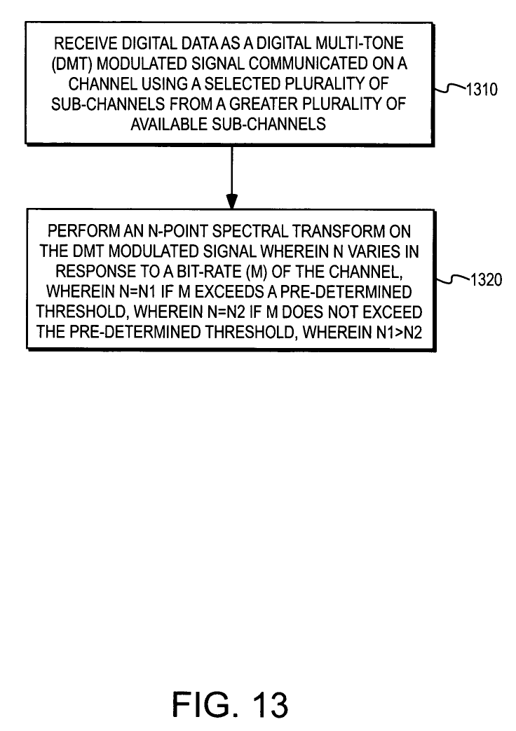

FIG. 13 illustrates one embodiment of a method of scaling a spectral transform in accordance with a channel bit-rate. Digital data is received as a DMT modulated signal in step 1310. The DMT modulated signal is communicated on a channel using a selected plurality of clustered sub-channels from a greater plurality of available sub-channels. An N-point spectral transform is performed on the DMT modulated signal in step 1220, wherein N varies in response to a bit-rate (M) of the channel.

There is at least one pre-determined threshold such that N=N1, if M exceeds a pre-determined threshold and N=N2, if M does not exceed the pre-determined threshold, wherein N1>N2. In various embodiments there are a plurality of pre-determined thresholds and N is selected from three or more values in response to M. The selected sub-channels may be equidistantly spaced. In one embodiment, the selected sub-channels are clustered near a lower bound of the channel.

In various embodiments, the spectral transform is a discrete Fourier transform or a fast Fourier transform. Typical values for N are 128, 256, or 512 depending upon the number of sub-channels. Given that variants of ADSL tend to vary the channel width by factors of 2, N1/N2 may be a power of 2 in some embodiments.

Although error correction is provided for by xDSL standards, the error correction afforded by Reed Solomon or trellis coding can consume considerable computational power. The digital data is pre-coded at the transmitter prior to modulation to aid in error detection and correction during demodulation at the receiver. Such error correction is optional. Indeed, the error correction is typically “off” due to the significant resources required, particularly for short loop installations where the performance gain is negligible. In such cases, no error decode function such as that provided by a trellis decoder is required.

Even a small change in N can free up significant computational resources otherwise required by the spectral transform. Referring to FIG. 4, Viterbi decoder 470 provides greater returns in a higher signal-to-noise communication environment. Indeed, for environments where the achievable bit-rate is relatively high, Viterbi decoder 470 tends to provide little return given its consumption of computational resources. In such cases, convolutional coding and CRC/Reed-Solomon coding are not required. The near-end and far-end modems co-operate so that the digital data being communicated is thus not convolutionally encoded and not Reed-Solomon encoded so that the sophisticated decoding provided by Viterbit decoder 470 and CRC/Reed-Solomon decoder 471 are not required.

The subscriber line may form a short loop, for example, such that the data may be distributed across the sub-channels in a manner to keep the errors below a rate that would justify the error detection/correction function provided by the trellis decoder.

In long loop applications, however, fewer sub-channels are available due to the degradation of the higher frequency sub-channels over distance. Thus, for example, an ADSL2+ modem might be limited to full-rate ADSL bandwidth in a long loop environment (i.e., reduced channel width) or communication might be limited to the use of sub-channels clustered near the lower bound of the channel. A greater data rate can be extracted from the limited number of sub-channels that can be used when a trellis decoder is implemented.

As noted above, the situations where the trellis decoder is computationally practical are situations in which the spectral transform may be scaled to result in significant computational savings. To avoid imposing significantly greater computational resources from either the modem processor or the host processor, the computational resources allocated for the spectral transform can be shared or shifted when the spectral transform is appropriately scaled. In particular, there may be a threshold point value where reducing the spectral transform below that value will save sufficient computational resources to enable using the error decode without significantly greater consumption of computational resources.

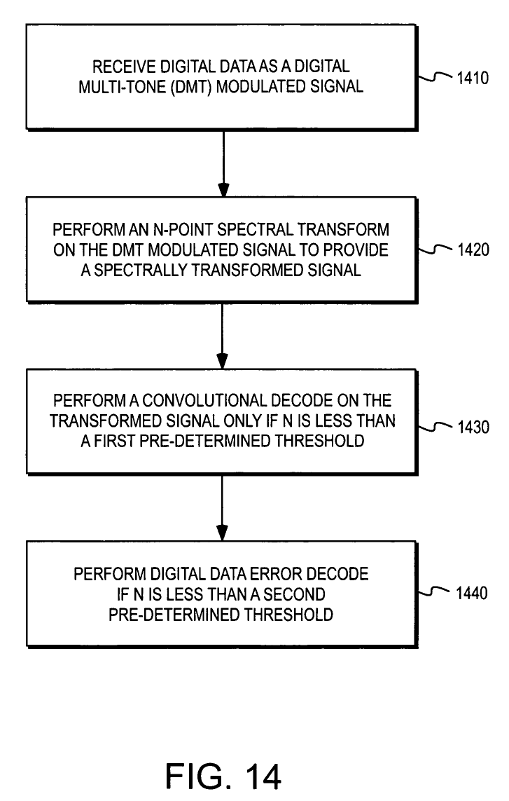

FIG. 14 illustrates one embodiment of a method of sharing computational resources between a spectral transform and error decoder. Digital data is received as a DMT modulated signal in step 1410. An N-point spectral transform is performed on the DMT modulated signal in step 1420 to form a spectrally transformed signal. In one embodiment, the transformed signal is convolutional decoded in step 1430 only if N is less than a first pre-determined threshold.

With respect to step 1440, digital data error decoding (e.g., CRC/Reed-Solomon decoding) is similarly applied only if N is less than a second pre-determined threshold. The use of convolutional coding is independent of the use of digital data error coding such that error decoding and convolutional decoding may independently be enabled. In one embodiment, separate thresholds are used when determining whether to implement convolutional coding and whether to use digital data error encoding. In another embodiment, convolutional coding and digital data error encoding are both implemented when N is less than the same pre-determined threshold (i.e., the first and second pre-determined thresholds are the same threshold).

In various embodiments, the spectral transform is a discrete Fourier transform or a fast Fourier transform. Typical values for N are 128, 256, or 512 depending upon the number of sub-channels within the channel. In various embodiments, the error decode function is performed by a trellis decoder. In various embodiments, the error decode function utilizes Reed-Solomon coding.

Referring to FIG. 4, yet another opportunity for varying the computational resources arise with respect to the manner in which the near-end transmitted signal is removed. Even if the xDSL modem uses frequency division multiplexing to separate the channels used for transmitting and receiving data, harmonics from the transmit channel (i.e., upstream from the viewpoint of an ATU-R) can spread into the receive channel (i.e., downstream from the viewpoint of an ATU-R). Generally, spectral components attributable to upstream channel communications should be eliminated to improve modem throughput.

One approach for removing the near-end transmitted signal is to use an echo canceller 430. In one embodiment, the echo canceller is a digital echo canceller. The echo canceller may be implemented as a program comprising processor-executable instructions with the near-end transmitted signal as an input. The output of the echo canceller is used to remove the near-end transmitted signal from the composite signal using summer 432. One particularly nice feature of the echo canceller is that it uses knowledge of the actual near-end transmitted signal and thus can be very effective at removing the near-end transmitted signal and any harmonics that would otherwise occur from the composite signal.

Another approach for removing the near-end transmitted signal is to use the high pass filter 452. The high pass filter simply eliminates spectral components below a cut-off frequency associated as a dividing point between the transmit and receive channels. The high pass filter cannot remove the harmonic contributions of the transmit channel that have spread into the receive channel. The high pass filter, however, requires significantly less computational resources than the echo canceller.

The modem does not require both the echo canceller and the high pass filter. The echo canceller can result in greater data throughput while the high pass filter is less taxing of the processor implementing the filter or echo canceller. The use of selectable echo canceller 430 and high pass filter 452 permits selection of the appropriate near-end signal cancellation approach based on whether cost of implementation or data throughput is more important. Use of the echo canceller, for example, may result in an undesirably responsiveness from the host processor or a higher cost modem depending upon the modem processor or host processor implementation.

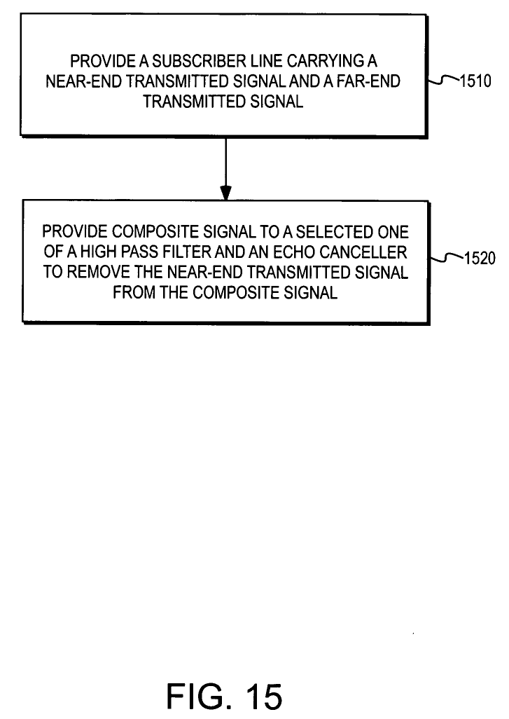

FIG. 15 illustrates one embodiment of a method of data communications. In step 1510, a near-end transceiver is coupled to a subscriber line carrying a composite signal carrying both the near-end transmitted signal and the far-end transmitted signal (i.e., the signal to be received). In step 1520, the composite signal is provided to a selected one of an echo canceller and a high pass filter to remove a near-end transmitted signal from the composite signal. The selection of one of the echo canceller and the high pass filter is exclusive to the selection of the other of the echo canceller and the high pass filter. Only one of the high pass filter and the echo canceller is enabled for elimination of the near-end transmitted signal from the composite signal.

Various methods and apparatus for processing a DMT modulated signal have been described. In particular, a modem using a shared multi-staged spectral transform for demodulation, a modem with a scalable spectral transform for demodulation, a modem using error coding in accordance with the scale of the demodulation spectral transform, and a modem with an exclusively selectable echo canceller and high pass filter for removal of near-end transmitted signals have been described. Where appropriate the methods or apparatus may be combined. The individual components of the modulation and demodulation functions of a modem may be performed by a host processor or a modem processor as previously described.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A communication apparatus, comprising:
a modem coupled to a subscriber line carrying a composite signal, the composite signal including a near-end transmitted signal and a far-end transmitted signal, the modem comprising:
a high pass filter; and
an echo canceller, wherein the composite signal is exclusively provided to a selected one of the echo canceller and the high pass filter for removing the near-end transmitted signal from the composite signal.

2. The apparatus of claim 1 wherein the composite signal includes digital data as a discrete multi-tone modulated signal.

3. The apparatus of claim 1 wherein the near-end transmitted signal and the far-end transmitted signal are frequency division multiplexed within the composite signal.

4. The apparatus of claim 1 wherein the echo canceller is a digital echo canceller.

5. The apparatus of claim 1 wherein the high pass filter is a digital high pass filter.

6. A method of data communication, comprising:
(a) providing a subscriber line carrying a near-end transmitted signal and a far-end transmitted signal as a composite signal; and
(b) providing the composite signal to an exclusively selected one of an echo canceller and a high pass filter for removal of the near-end transmitted signal.

7. The method of claim 6 wherein the composite signal includes digital data as a discrete multi-tone modulated signal.

8. The method of claim 6 wherein the near-end transmitted signal and the far-end transmitted signal are frequency division multiplexed within the composite signal.

9. The method of claim 6 wherein the echo canceller is a digital echo canceller.

10. The method of claim 6 wherein the high pass filter is a digital high pass filter.
